(19) United States
(12) Patent Application Publication
(10) Pub. No.: US 2011/0026603 A1
(43) Pub. Date: Feb. 3, 2011

(54) METHOD AND APPARATUS OF USING SYSTEM MEMORY FOR 3D COMB FILTERING FOR VIDEO DECODING

(75) Inventors: Lei Zhang, Richmond Hill (CA); Sharon Shen, Shanghai (CN); Zhong Cai, Shanghai (CN); Min Yu, Shanghai (CN)

Correspondence Address: ADVANCED MICRO DEVICES, INC.;C/O VEDDER PRICE P.C., 222 N.LASALLE STREET, CHICAGO, IL, 60601, US

(73) Assignee: AMD (SHANGHAI) CO., LTD., Shanghai (CN)

(21) Appl. No.: 12/831,525

(22) Filed: Jul. 7, 2010

(30) Foreign Application Priority Data
Jul. 8, 2009 (CN) 200910054505.5

(51) Int. Cl. H04N 7/26; G06F 12/10

(52) U.S. Cl. 375/240.25; 711/206; 711/E12.061; 375/E07.027

(57) ABSTRACT

Method and apparatus of using a system memory for 3D comb filtering for PCTV application are provided. Firstly, the data reading/writing in a logic address may be controlled, and mapping the logic address to a physical address in the system memory, and actually reading/writing data in the physical address. A RSM and a WSM may be used to control reading/writing data in the logic address respectively, wherein the WSM switching among its idle status, request status, and processing status, and the RSM switches among its idle status, request status and waiting status. An address mapping table may be used to record the logic address and corresponding physical address. Upon obtaining the physical address via the address mapping table, actually reading/writing data in the physical address. Method and apparatus for adaptively controlling of 3D comb filter on/off depending on the status of the video decoder and on-chip memory. The present invention is advantageous for using system memory for 3D comb filtering over two or more frames.

### TECHNICAL FIELD

The present invention relates to method and apparatus for 3D comb filtering, and more particularly, to data reading and writing during 3D comb filtering.

### BACKGROUND ART

A composite video signal is the sum of a luminance (brightness) signal and a chrominance (color) signal. These signals may be referred to as luma and chroma signals, respectively. The frequency ranges of the luma and chroma signals may be designed to overlap. The luma signal may extend from DC to 4.2 MHz and the chroma signal may be centered at 3.58 MHz with a bandwidth of 1.8 MHz. In video processing, the luma and chroma signal components may be added together in order to generate a composite video signal. The luma and chroma video elements may be integrated and broadcasted as a single composite video stream. Once the composite signal is received, the luma and chroma signal components must be separated in order for the video signal to be processed and displayed.

A typical color TV decoder receives a composite TV signal as input. A comb filter may be utilized for separating the chroma and luma video signal components. For example, a television may be adapted to receive a composite video input and utilize an integrated comb filter to separate the chroma and luma video signal components. However, before the television may display the received video signal, the chroma and luma video components may have to be separated.

In conventional video processing, there may be several ways to separate the luma and chroma video components. These may include combing horizontally, combing vertically, and combing temporally. Each of these combing methods may have certain disadvantages. For example, in horizontal combing a notch filter at 3.58 MHz may be used to separate the chroma from the luma. This, however, may result in a loss of luma information around the notch frequency.

In vertical combing, a given line of video may be added and/or subtracted from the video line above and below the given line, yielding a luma and chroma signal. This may work because the chroma signal alternates by 180 degrees from one line to the next and two adjacent lines may contain almost identical information. Although better than horizontal combing, artifacts may be produced when adjacent lines are, for example, different from one another.

In temporal combing two frames of video may be compared. In temporal combing an assumption may be made that the video information between adjacent frames has not changed. Also, the chroma phase on any given line may be 180 degrees out of phase with the corresponding line on an adjacent frame. Given these two assumptions, the difference between adjacent frames may yield a luma and chroma signal, free from the artifacts of a horizontal coming system and a vertical coming system. However, performing temporal combing where the information between adjacent frames has changed may become challenging.

Currently, 3D comb filter is the best comb filter, which could separate luma and chroma signal in space and in time. PCTV is a relatively new application in PC industry. Broadly speaking, PCTV makes it possible to watch TV on PC system. A TV card is necessary for PCTV application, which includes a video decoder. There are two conflicting requirements in the PCTV application. PCTV requires a low cost total solution while maintaining high video quality on analog TV input or composite video input. Similar to a typical TV video decoder, 3D comb filter is used in a PCTV video decoder to provide good video quality. However, 3D comb filter requires a large amount of storage space, and, many efforts have been made to solve this problem.

The known relevant solutions that implement the storage space required by 3D comb filtering are 1) external SDRAM, 2) SDRAM die packaged in a multi-die package; and 3) embedded SDRAM on the same silicon. But, all of these solutions are too expensive to be widely applied in PCTV applications. Therefore, method and apparatus that could implement the large amount of storage space without increasing the cost are still needed.

### SUMMARY OF EMBODIMENTS OF THE INVENTION

One of the objects of the present invention is providing a technology for providing large memory for 3D comb filtering with reduced or even no additional cost. A further object of one embodiment of the present invention is providing a technology for using system memory for 3D comb filtering. A further object of one embodiment of the present invention is providing a technology for adaptively controlling the operation of 3D comb filter.

In accordance with one aspect of the present invention, an apparatus for using system memory for 3D comb filter in video decoding is provided, comprising a reading/writing control device for controlling the reading/writing in a logic address, and an address mapping device for mapping the logic address to a physical address of a system memory, and actually reading/writing in the physical address.

The reading/writing control device comprises at least one state machine (SM). Further, the reading/writing control device includes reading SM (RSM) and writing SM (WSM). The reading/writing control device further includes a counter for recording the number of reading/writing request. The reading/writing control device further includes a data converting device for converting the data from input format to storage format and from storage format to output format.

The address mapping device comprises an address mapping table, in which a plurality of logic addresses and corresponding physical addresses are recorded. Further, the address mapping device also comprises a request path module and a data transfer path module.

In accordance with another aspect of the present invention, a method of using a system memory for 3D comb filtering in video decoding is provided, comprising: reading/writing in a logic address; and mapping the logic address to a physical address in a system memory, and actually reading/writing data in the physical address.

In accordance with still another aspect of the present invention, a TV card PCTV application is provided, comprising a video decoder with 3D comb filter, an on-chip memory, an on-chip memory controller, and an interface, wherein the video decoder further comprises a reading/writing control device for controlling the reading/writing of data in a logic address; and an address mapping device for mapping the logic address to a physical address in a system memory, and actually reading/writing data in the physical address.

In accordance with still another aspect of the present invention, an operation control apparatus for controlling the operation of TV card above is provided, comprising: a first detection device for detecting the operation status of the video decoder, a second detection device for detecting the status of the on-chip memory, and control device for enabling or disabling the 3D comb filter depending on the results of the first and second detection devices.

In accordance with still another aspect of the present invention, a method for controlling the operation of the TV card above is provided, comprising detecting the operation status of the video decoder, detecting the status of the on-chip memory and enabling or disabling the 3D comb filter depending on the results of the above detecting.

In accordance with still another aspect of the present invention, a system for PCTV application comprising a video decoder with 3D comb filter, an on-chip memory, an on-chip memory controller, and an interface is provided. The system further comprises operation control apparatus, wherein the video decoder comprises: reading/writing control device for controlling data reading/writing in a logic address; address mapping device for mapping the logic address to a physical address in a system memory, and actually reading/writing data in the physical address. The operation control apparatus includes: a first detection device for detecting the operation status of the video decoder; a second detection device for detecting the status of the on-chip memory; and a control device for enabling or disabling the 3D comb filter depending on the results of the first and second detection device.

In accordance with still another aspect of the present invention, providing a manufacture article with computer-readable medium, in which a computer-readable code for using the system memory for 3D comb filtering in a video decoder is stored, comprising: a computer-readable code for controlling the data reading/writing in a logic address; and computer-readable code for mapping the logic address to a physical address in a system memory and actually reading/writing data in the physical address.

The computer-readable code for controlling the data reading/writing in a logic address includes a computer-readable code for controlling the status switch of the RSM to read data, and a computer-readable code for controlling the status switch of the WSM to write data.

Computer-readable code for mapping the logic address to a physical address in a system memory further includes a computer-readable code for converting the logic address to a physical address based on an address mapping table. A computer-readable code for mapping the logic address to a physical address in a system memory further includes a computer-readable code for exchanging data with an external equipment according to the physical address resulted from such converting.

In accordance with still another aspect of the present invention, providing a manufacture article with a computer-readable medium, in which a computer-readable code for controlling the operation of the antecedent TV card is stored, comprising a computer-readable code for detecting the operation status of the video decoder, a computer-readable code for detecting the status of the on-chip memory, and a computer-readable code for enabling or disabling the 3D comb filter depending on the output of above detecting.

With the present invention, system memory could be used for 3D comb filtering. For example, in PCTV application, as the system memory is much larger the on-chip memory, the effect of the 3D comb filtering is much better than that of the prior art. And thus, the additional cost in hardware is greatly reduced compared to the prior art, or even no additional cost needed. And further, the 3D comb filter could be adaptively controlled on/off, depending on the status of the 3D comb filter and on-chip memory.

### BRIEF DESCRIPTION OF THE DRAWINGS

These and other features of the present invention will be described in more detail in the following detail description, in conjunction with the figures of the accompanying drawings, the present invention is illustrated by way of example and not by way of limitation in the figures, and in which,

FIG. 1 shows an apparatus for using the system memory for 3D comb filtering, in accordance with one embodiment of the present invention.

FIG. 2 shows the schematic view of the operation of WSM, in accordance with one embodiment of the present invention.

FIG. 3 shows the schematic view of the operation of RSM, in accordance with one embodiment of the present invention.

FIG. 4 shows the reading/writing in the logic addresses performed by the reading/writing control device.

FIG. 5 shows the high-level flow chart of the method for using the system memory, in accordance with one embodiment of the present invention.

FIG. 6 shows a TV card with the antecedent apparatus, in accordance with one embodiment of the present invention.

FIG. 7 shows an operation control apparatus, in accordance with one embodiment of the present invention.

FIG. 8 shows a method for operation control, in accordance with one embodiment of the present invention.

### DESCRIPTION OF PREFERRED EMBODIMENTS

The present invention will now be described in detail with reference to a few embodiments thereof as illustrated in the accompanying drawings. In the following description, numerous specific details are set forth in order to provide a thorough understanding of the present invention. However, it will be apparent to one skilled in the art that the present invention may be practiced without some or all of these specific details. In other instance, well-known process steps and/or structures have not been described in detail in order not to unnecessarily obscure the present invention.

FIG. 1 is a schematic block diagram showing an apparatus 100 for using the system memory for the 3D comb filtering, in accordance with one embodiment of the present invention, which is applied to the video decoder in TV card for PCTV application. Preferably, said system memory refers to PC system memory, however, it is not intended to limit the present invention to PC system memory.

The apparatus 100 comprises a reading/writing control device 110 and an address mapping device 120. The reading/writing control device 110 controls data reading and/or writing in a logic address. The address mapping device 120 maps the logic address to a physical address in a system memory, and actually reads and/or writes in the physical address. As is known in the art, the data described above include image data and/or motion detection flags. In the present invention, the data is associated with at least two frame images, i.e. including, but not limited to, two frames, three frames or more.

In one embodiment, the reading/writing control device 110 employs a SM (not shown) to control data reading and writing. The SM switches among its idle, request, waiting, and processing status. During Reading, the SM switches among the idle, the request, the waiting status; while during Writing, the SM switches among the idle, the request, and the processing status.

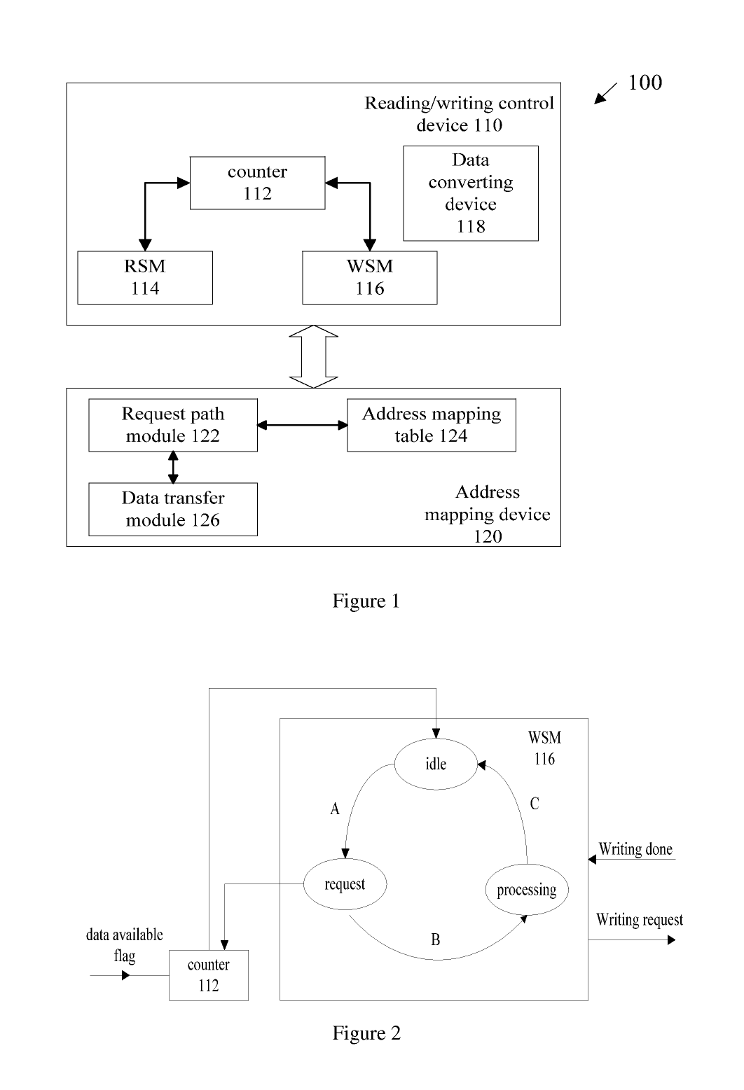

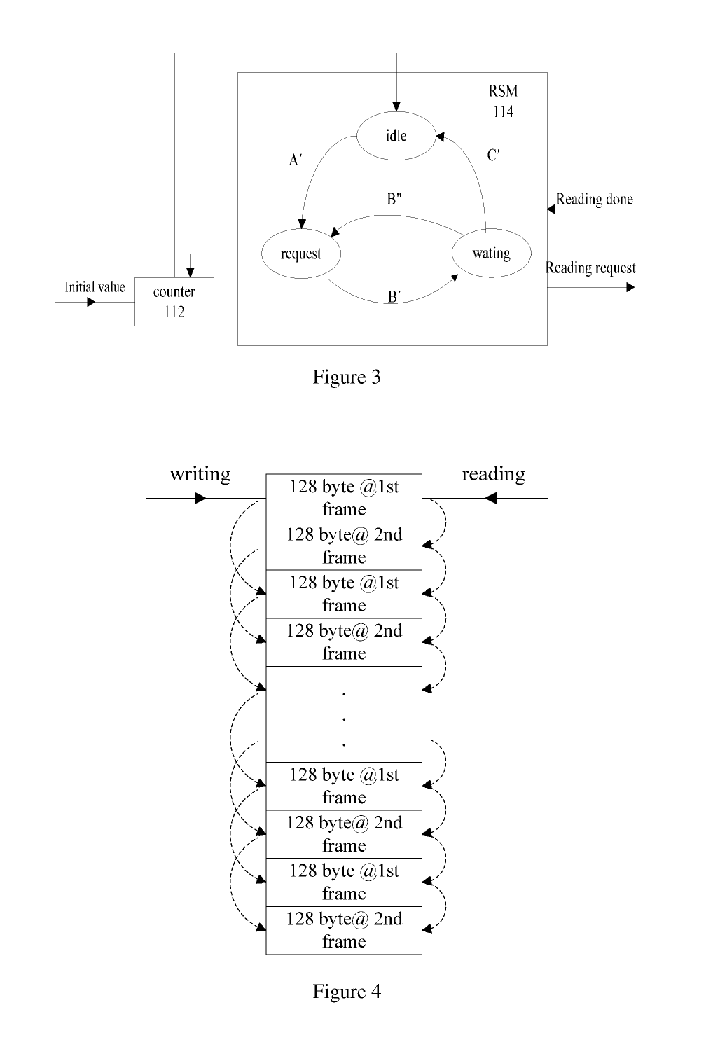

As shown in FIG. 1, in one embodiment, the reading/writing control device 110 utilizes RSM 114 and WSM 116 to control data reading and writing respectively, wherein the WSM 116 switches among the idle, the request, and the processing status, as shown in FIG. 2, and the RSM 114 switches among the idle, the request and the waiting status, as shown in FIG. 3. The reading/writing control device 100 further includes an counter 112, in which the amount of the reading and/or writing request are recorded, and changes the status of the SMs described above depending on the amount of the reading/writing request. However, it will be appreciated by one skilled on the art that the RSM 114 and WSM 116 code be configured with separate counters (not shown) for recording the amount of the requests therein, respectively.

With reference to FIG. 2, it schematically shows the status switch process of WSM 116. Hereinafter, the writing process is described with the image data as an example, which is similar with that of the motion detection flags. Upon receiving a writing request, the value of the counter 112 increases by 1. In one embodiment, said writing request is a request that indicates writing data in a memory. In one embodiment, a data available flag could be used to identify the writing request. While the flag is TRUE, it indicates that a writing request has been received, vice versa.

With reference to FIG. 1, the reading/writing control device further includes a data converting device 118. During writing, the device 118 converts the received data to a desired storage format; during reading, the device 118 converts the read data to a desired output format. In one example, the bit width of the received data is 12 bits, and is converted to a storage format with a bit width of 64 bits. Any suitable method could be utilized to perform such converting, including, but not limited to, filling the unused bit width with 1 or 0, or combining multiple data to a storage package of data. The bit width of the output format is 12 bits, and during reading, a data in storage format with a bit width of 64 bits will be converted to an output format. A reverse method could also be utilized, which is apparent to one skilled in the art.

When the value of the counter increases beyond the first predetermined threshold, the WSM 116 will switch from the idle status to the request status, as indicated by Arrow A, during which a writing request is sent to the address mapping device 120. With reference to FIG. 1, the address mapping device 120 comprises address mapping table 124, and the address mapping table 124 records the logic addresses and the corresponding physical addresses. The address mapping device 120 further comprises a request path module 122, which converts the logic address to the physical address according to the address mapping table 124. The address mapping device 120 further comprises a data transfer path module 126, which exchanges data with an external equipment according the physical address resulted from such converting. The external equipment will be set forth hereinafter.

In one embodiment, it will be appreciated by one skilled in the art, the physical address corresponding to the logic address in the address mapping table 124 is applied by a driver program (not shown) to the operation system. “Driver program” and “operation system” are both the generic terms in the art, the meaning of which are well known to those skilled in the art. Further, applying the physical address to the operation system is also well-known.

In one embodiment, when a writing request is accepted, the value of the counter 112 decreases by 1. While the value of the counter 112 equals to 1, the WSM 116 will switch to the processing status, as indicated by Arrow B, and wait for the accomplishment of data storing. When the storing is done, i.e., the writing process is accomplished, the WSM 116 will switch to the idle status, as indicated by Arrow C.

With reference to FIG. 3, it schematically shows the status switch process of the RSM 114 with respect to the instance of reading two frames of image. Similarly, the following description takes the reading process of image data as an example. Initially, the local memory is empty. The local memory differs from the system memory, and can also be referred to as on-chip memory, which will be recited below. It can be understood by one skilled in the art that, in order to ensure sufficient data in the video decoder, the value of the counter 112 should be set to a particular initial value depending on the size of the local memory and the system waiting time; however, since the value of the counter 112 equals to the amount of the reading request, the initial value of the amount of reading request is actually set. The reading request is the request that indicates reading data from the memory. Obviously, the memory refers to the system memory herein.

If the value of the counter 112 is bigger than a second predetermined threshold, the status of the RSM 114 will switch from the idle status to the request status, as indicated by Arrow A′, during which a reading request is sent to the address mapping device 120, requesting to read the first frame of image data, and the RSM will switch to the waiting status, as indicated by Arrow B′, and the amount of the reading request decreases by 1.

As with what is described above, the address mapping device 120 gets the physical address corresponding to the logic address according to the address mapping table 124 via the request path module 122, and exchanges data with an external equipment via the data transfer module 126 so as to read the desired data.

When the reading request decreases to 4, the RSM will switch to the request status, as indicated by Arrow B″. Then, a reading request will be sent, requesting the second frame of the image data. And again, the RSM switches to the waiting status. While the reading request decreases to zero, i.e., no more data is required, the SM will switch to the idle status, as indicated by Arrow C′.

Likewise, the read data is converted to an output format by the data converting device 118.

In the case of interlaced scanning, each frame of images has two fields. Consider the case wherein the data consist of two portions: the motion detection flags of current point and two frames of the image data prior to the current frame, which may be utilized as the reference data for the 3D comb filter. As such, two frames of image data is required to be read and stored. Of course, the more frames are used, the better the image quality will be. However, at least two frames are required to perform 3D comb filtering.

With reference to FIG. 4, it shows the means of the reading/writing control device storing data in the logic address, in accordance with an embodiment of the present invention. In PCTV application, reading data occurs more frequently by far than storing (writing) data, and thus, in order to improve the reading speed, the data of the two frames of images may be stored alternately. For example, in order to improve the access efficiency, in one embodiment, the size of data stored each time is 128 byte, depending on the configuration of the hardware. Consequently, the 128-byte data from the first field of the first frame may be stored, followed by storing the 128-byte data from the first field of second frame in the next logic address. In this manner, while storing the data from the first field is done, the 128-byte data from the second field of the first frame is stored, then, the 128-byte data from the second field of the second frame is stored in the next logic address. In this way, when used, the data of the two frames are read simultaneously, for performing 3D comb filtering computation. The 128 byte of each frame will be read each time.

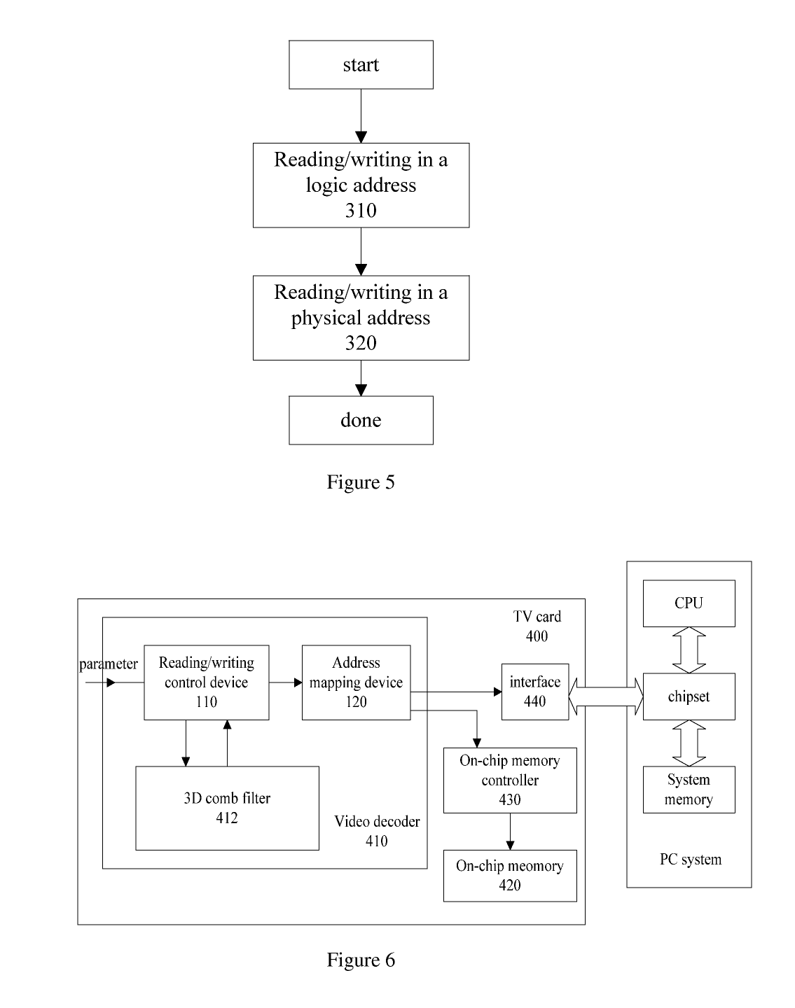

With reference to FIG. 5, in the description above, the present invention also provides a method 300 of using the system memory for 3D comb filtering. In operation 310, RSM 114, WSM 116, and a counter 112 are utilized to control reading and writing data in a logic address. In operation 320, map the logic address to a physical address by an address mapping table 124, and actually read and write data in the system memory according to the physical address.

With reference to FIG. 6, it shows a TV card 400 comprising a video decoder 410 with 3D comb filter 412, further comprising an on-chip memory 420, an on-chip memory controller 430, and an interface 440. The TV card 400 further comprises the apparatus 100 described above, wherein the reading/writing control device 110 may be coupled to the 3D comb filter 412 for data exchanging, and the address mapping device 120 may be coupled to the interface 440 and the on-chip memory controller 430. The on-chip memory controller 430 controls the data access in the on-chip memory 420, which is the local memory recited hereinbefore. In one embodiment, the interface is a PCIe interface. FIG. 6 further shows parts of a PC system, which are examples of the external equipment, including chipset, CPU, and system memory. In one embodiment, the video decoder with 3D comb filter, on-chip memory, on-chip memory controller are embodied inside a PCTV ASIC, and the PCTV ASIC is in turn sit on a PCTV card board. However, there are many ways to implement said PCTV card, and it should be understood that the specific embodiment described above is not intended in any way to limit the present invention.

As mentioned earlier, the address mapping device 120 obtains the physical address in a system memory, then reads data from the system memory or writes data in the system memory via the PCIe bus and/or the chipset. Any suitable means may be employed to implement the process. In one embodiment, the logic address is the address in the on-chip memory.

Alternatively, in another embodiment, the logic address is only a symbol address, not the address in any said memory. In this manner, the data to be written or read is stored in one or more buffer different from the on-chip memory. It can be understood by one skilled in the art that any suitable means may be employed to implement such an embodiment.

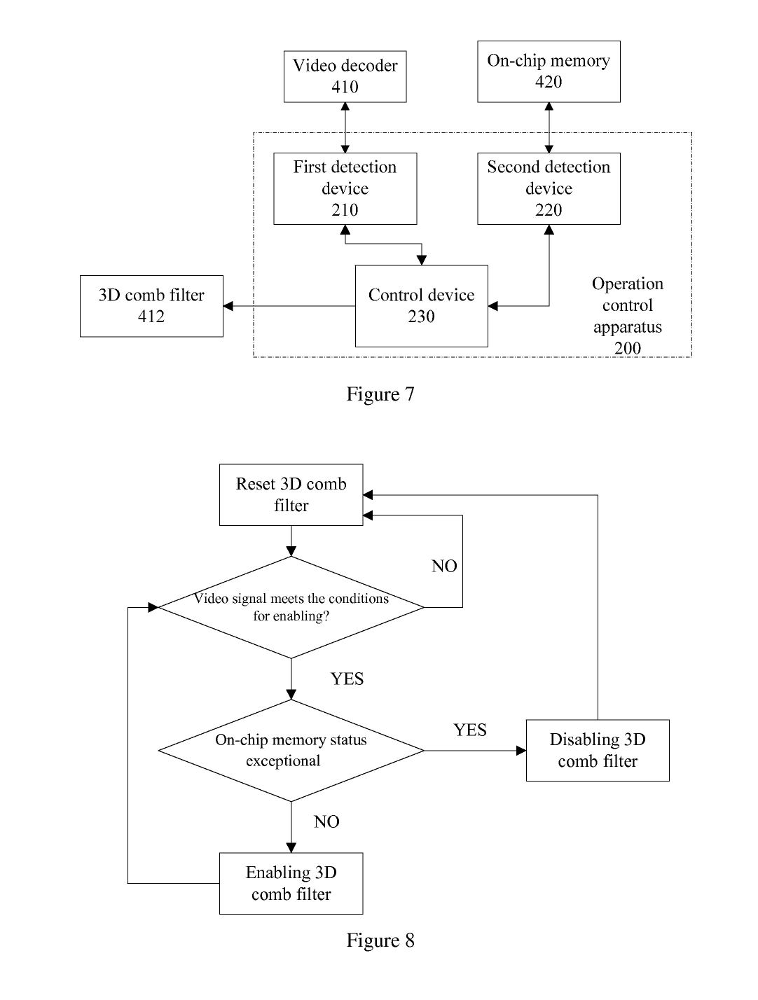

With reference to FIG. 7, it shows an operation control apparatus 200 for controlling the operation of the TV card described above, comprising a first detection device 210, a second detection device 220, and a control device 230. The first detection device 210 is used to detect the operation status of the video decoder 410, i.e. detecting whether the video signals inputted in the video decoder meet the condition for enabling the 3D comb filter 412, so as for the control device 230 to decide enabling the 3D comb filter 412 or not depending on the result of detecting, which is in the form of output signals in one embodiment. For example, while switching channels or there is no TV program on the current channel, the 3D comb filter 412 may not be required to be enabled, so as to lower the data transferring over the PCIe bus and accordingly lower the power consumption of the system.

The second detection device 220 is used to detect whether the data in the on-chip memory 420 is properly stored and read. When an exception occurs with the status of on-chip memory 420, the control device 230 will disable the 3D comb filter 412 and the reading/writing control device 110 simultaneously. The exception of the status of on-chip memory 420 may refer to the improperly storing/reading of data resulted from the bandwidth of PCIe. Disable the 3D comb filter 412 and release the occupied PCIe bandwidth. After a while, restore enabling the 3D comb filter 412. In this manner, the unpredictable problems occurred in the PCIe bus can be solved, thereby avoid improperly enabling the 3D comb filtering due to the PCIe bandwidth issue, ensuring that the best quality video output is provided to the users. FIG. 8 shows an operation control method corresponding to the operation control apparatus.

The present invention further provides a system, which incorporates the TV card and the operation control apparatus described above, the configuration of which has been recited hereinbefore in detail, and is briefly recited herein for succinct purpose.

The present invention further provides a manufacture article with a computer-readable medium, in which a computer-readable code for using the system memory for 3D comb filtering in the video decoder is stored, comprising: a computer-readable code for controlling the data reading/writing in a logic address; and a computer-readable code for mapping the logic address to a physical address in a system memory and actually reading/writing data in the physical address.

In one embodiment, the computer-readable code for controlling the data reading/writing in a logic address comprises a computer-readable code for controlling the status switch of the at least one SM

In another embodiment, the computer-readable code for controlling the data reading/writing in a logic address comprises a computer-readable code for controlling the status switch of RSM to read data and a computer-readable code for controlling the status switch of WSM to write data.

The computer-readable code for controlling the RSM controls said RSM switching among its idle status, request status, and waiting status, the computer-readable code for controlling the WSM controls said WSM switching among its idle status, request status, and processing status.

The computer-readable code for controlling the status switch of the at least one SM further includes a counting variable for recording the amount of reading or writing requests, and switching the status of the SM depending on said counting variable.

The computer-readable code for controlling the status switch of the at least one SM further includes a computer-readable code for performing data conversion, converting the data from an input format to a storage format and from a storage format to an output format.

The computer-readable code for mapping the logic address to a physical address in a system memory further includes a computer-readable code for converting the logic address to the physical address according to an address mapping table. The address mapping table is the same as described hereinbefore.

The computer-readable code for mapping the logic address to a physical address in a system memory further includes a computer-readable code for exchanging data with an external equipment according to the physical address resulted from the converting.

The computer-readable code for controlling the status switch of the at least one SM further includes a computer-readable code for storing the data of at least two frame of images alternately.

In a further embodiment of the present invention, a manufacture article with a computer-readable medium is provided, in which a computer-readable code for controlling the operation of the antecedent TV card is stored, comprising a computer-readable code for detecting the operation status of the video decoder, a computer-readable code for detecting the status of the on-chip memory and a computer-readable code for enabling or disabling the 3D comb filter depending on the detection result.

The computer-readable code for detecting the operation status of the video decoder includes a computer-readable code for detecting whether the video signals inputted in the video decoder meet the conditions for enabling the 3D comb filter. For example, during switching channels or no program on current channel, the operation status of the video decoder does not meet the condition for enabling the 3D comb filter.

The computer-readable code for detecting the status of the on-chip memory includes a computer-readable code for detecting whether the data in the on-chip memory is properly stored and read.

The computer-readable code for enabling or disabling the 3D comb filter disables the reading/writing control device while disables the 3D comb filter.

While the present invention has been described in terms of several preferred embodiments, there are alterations, permutations, and equivalents, which fall within the scope of this invention. It should be noted that there are many alternative ways of implementing the methods and apparatus of the present invention. Therefore, it is intended that the following appended claims be interpreted as including all such alterations, permutations, and equivalents as fall within the true spirit and scope of the present invention.

What is claimed is:

1. An apparatus of using system memory for 3D comb filtering in video decoding, comprising:
a reading/writing control device operative to control reading/writing the data associated with at least two frames of images in a logic address; and
an address mapping device operative to map said logic address to a physical address in said system memory, and actually reading/writing data in said physical address.

2. The apparatus of claim 1, wherein said reading/writing control device comprises a reading SM (RSM) and a writing SM (WSM), and wherein said RSM switches among its idle status, request status, and waiting status, said WSM switches among its idle status, request status, and processing status.

3. The apparatus of claim 1, wherein said reading/writing control device further comprises a counter, which recording the amount of reading or writing request, and switching the status of the SM depending on the value of said counter.

4. The apparatus of claim 1, wherein said reading/writing control device further comprises a data converting device for converting the received data of the apparatus to a desired storage format, and converting the read data to a desired output format.

5. The apparatus of claim 1, wherein said address mapping device comprises an address mapping table, in which a plurality of logic addresses and corresponding physical addresses are recorded.

6. The apparatus of claim 5, wherein said address mapping device further includes a request path module, which converting said logic address to said physical address according to said address mapping table.

7. The apparatus of claim 6, wherein said address mapping device further comprises a data transfer path module, which exchanging data with an external equipment based on said physical address.

8. The apparatus of claim 1, wherein said reading/writing control device stores the data of said at least two frames of images alternately.

9. A TV card for PCTV application comprising a video decoder with 3D comb filter, an on-chip memory, an on-chip memory controller, and an interface, wherein said video decoder further comprises:
a reading/writing control device, operative to control reading/writing the data associated with at least two frames of images in a logic address;
an address mapping device, operative to map said logic address to a physical address in a system memory, and actually reading/writing data in said physical address.

10. The TV card of claim 9, wherein said reading/writing control device comprises a RSM and a WSM, and wherein said RSM switches among its idle status, request status, and waiting status, said WSM switches among its idle status, request status, and processing status.

11. The TV card of claim 9, wherein said reading/writing control device further comprises a counter, which recording the amount of reading or writing request, and switching the status of said RSM or WSM based on the value of said counter.

12. The TV card of claim 9, wherein said reading/writing control device further comprises a data converting device, which converting a received data to a desired storage format, and converting a read data to a desired output format.

13. The TV card of claim 9, wherein said address mapping device comprises an address mapping table, in which a plurality of logic addresses and corresponding physical addresses are recorded.

14. The TV card of claim 13, wherein said address mapping device further comprises a request path module, which converting said logic address to said physical address according to said address mapping table.

15. The TV card of claim 14, said address mapping device further comprises a data transfer path module, which exchanging data with external equipments based on said physical address resulted from said converting.

16. The TV card of claim 9, wherein said reading/writing control device stores the data of said at least two frames of images alternately.

17. The TV card of claim 9, wherein said logic address is the address in said on-chip memory, and wherein said address mapping device is coupled to said interface and said on-chip memory controller, and accesses said system memory via said interface.

18. A system for PCTV application comprising a video decoder with a 3D comb filter, a on-chip memory, a on-chip memory controller, and an interface, further comprising an operation control apparatus, wherein
said video decoder comprises:
a reading/writing control device, for controlling reading/writing the data associated with at least two frames of images in a logic address; and
an address mapping device, for mapping said logic address to a physical address in the system memory, and actually reading/writing data in said physical address;
said operation control apparatus comprises:
a first detection device, for detecting the operation status of the video decoder;
a second detection device, for detecting the status of the on-chip memory;
a control device, for enabling or disabling the 3D comb filter depending on the output of said first and second detection device.

19. The system of claim 18, wherein said first detection device detects whether the video signals inputted in the video decoder meet the condition for enabling the 3D comb filter.

20. The system of claim 18, wherein said second detection device detects whether the data in the on-chip memory is properly stored and read.

21. The system of claim 18, wherein said control device disables the reading/writing control device while disabling the 3D comb filter.

22. The system of claim 18, wherein said address mapping device is coupled between said interface and said on-chip memory controller, and accesses said system memory via said interface, and wherein said logic address is the address in said on-chip memory.

23. The system of claim 18, wherein said reading/writing control device comprises a RSM and a WSM, and wherein said RSM switches among its idle status, request status, and waiting status, said WSM switches among its idle status, request status, and processing status.

24. The system of claim 23, wherein said reading/writing control device further comprises a counter, which recording the amount of reading or writing request, and switching the status of said RSM or WSM based on the value of said counter.

25. The system of claim 24, wherein said reading/writing control device further comprises a data converting device, which converting the received data of the apparatus to a desired storage format, and converting the read data to a desired output format.

26. The system of claim 25, wherein said address mapping device comprises an address mapping table, in which a plurality of logic addresses and corresponding physical addresses are recorded.

27. The system of claim 26, wherein said address mapping device further comprises a request path module, which converting said logic address to said physical address according to said address mapping table.

28. The system of claim 27, wherein said address mapping device further comprises a data transfer path module, which exchanging data with an external equipment based on said physical address.

29. The system of claim 18, wherein said reading/writing control device stores the data of said at least two frames of images alternately.

30. A method for 3D comb filtering in video decoding comprising:
controlling reading/writing the data associated with at least two frames of images in a logic address; and
mapping said logic address to a physical address in a system memory, and actually reading/writing data in said physical address.
